(19) United States
(12) Patent Application Publication
(10) Pub. No.: US 2016/0036233 A1
(43) Pub. Date: Feb. 4, 2016

(54) SERIES-PARALLEL CONVERSION POWER DEVICE

(71) Applicant: SAMSUNG SDI CO. LTD., Yongin-si (KR)

(72) Inventor: Makoto YATSU, Minoh-shi (JP)

(21) Appl. No.: 14/714,605

(22) Filed: May 18, 2015

(30) Foreign Application Priority Data
Jul. 29, 2014 (JP) 2014-154293
Jan. 27, 2015 (KR) 10-2015-0013051

(51) Int. Cl. H02J 3/38

(52) U.S. Cl. CPC H02J 3/383

(57) ABSTRACT

A series-parallel conversion device includes n cell series connection units and a plurality of inter-unit connection switches. Each connection unit has n−1 cells and one intra-unit switch. The connection switches connect adjacent connection units. The connection units are disposed in parallel in n columns between a positive electrode terminal and a negative electrode terminal. The intra-unit switch in a cell series connection unit column has a first terminal and a second terminal. The first terminal is connected to a negative electrode terminal of a k-th cell from the negative electrode terminal or the positive electrode terminal. The second terminal is connected to a positive electrode terminal of a (k−1)-th cell from the negative electrode terminal or the negative electrode terminal. The connection switch is connected between the first terminal of the intra-unit switch of the k-th column and a second terminal of an intra-unit switch of a (k+1)-th column.

### CROSS-REFERENCE TO RELATED APPLICATIONS

Japanese Patent Application No. 2014-154293, filed on Jul. 29, 2014, and Korean Patent Application No. 10-2015-0013051, filed on Jan. 27, 2015, and entitled, “Series-Parallel Conversion Power Device,” are incorporated by reference herein in their entirety.

### BACKGROUND

1. Field

One or more embodiments relate to a series-parallel conversion power device.

2. Description of the Related Art

The output voltage of a battery or solar cell may change depending on the state of the cell. For example, the output voltage of a lead storage battery may change by about 30% (e.g., from about 1.6 V to 2.2 V per cell) depending on the State of Charge (SOC) and the amount of output current. The output voltage of a lithium ion cell may change by about 35% (e.g., from about 2.7 V to 4.2 V per cell) depending on the SOC and the amount of output current.

In order to stabilize cell output, a semiconductor power conversion device may absorb changes in output voltage in order to supply specific power to a load. However, the change in output voltage of the cell may cause a change in input voltage to the semiconductor power conversion device. Thus, the power conversion device may experience increased loss for increasing changes in the output voltage of the cell.

In an attempt to reduce this loss, a series-parallel conversion power device may be used to absorb changes in voltage of a single cell by changing the number of series and parallel cells connected in a multiple series and multiple parallel manner. However, current series-parallel conversion power devices may not uniformly distribute load to all cells. Accordingly, it may be difficult to maintain a sufficient cycle life or to protect the cell after being repeatedly charged and discharged.

### SUMMARY

In accordance with one or more embodiment, a series-parallel conversion power device includes n cell series connection units, each having n−1 cells and one intra-unit switch connected in series; and a plurality of inter-unit connection switches to connect adjacent cell series connection units of the n cell series connection units, wherein: the n cell series connection units are disposed in parallel in n columns between a positive electrode charging/discharging terminal and a negative electrode charging/discharging terminal, the intra-unit switch in a cell series connection unit of a k (k is 1 or more and n or less) column has a first terminal connected to a negative electrode terminal of a k-th cell from the negative electrode charging/discharging terminal or the positive electrode charging/discharging terminal (k=n) and has a second terminal connected to a positive electrode terminal of a (k−1)-th cell from the negative electrode charging/discharging terminal or the negative electrode charging/discharging terminal (k=1), and the inter-unit connection switch is connected between the first terminal of the intra-unit switch of the k-th column and a second terminal of an intra-unit switch of a (k+1)-th column.

If the cells have an n−1 series and n parallel state, the intra-unit switch may be in an on state and the inter-unit connection switch is to be in an off state, and if the cells have an n series and n−1 parallel state, the intra-unit switch may be in an off state and the inter-unit connection switch is to be in on state. Each of the intra-unit switch and the inter-unit connection switch may include a combination of a self-commutated semiconductor switch and a diode reversely connected in parallel to the self-commutated semiconductor switch. Each of the intra-unit switch and the inter-unit connection switch may include a combination of a mechanical switch and a diode connected in parallel to the mechanical switch.

The intra-unit switch may include a diode, and the inter-unit connection switch may include a mechanical switch or a self-commutated semiconductor switch. The cell may include a solar cell, the intra-unit switch may include a diode, and the inter-unit connection switch may include a switch having a backdraft prevention function.

### BRIEF DESCRIPTION OF THE DRAWINGS

Features will become apparent to those of skill in the art by describing in detail exemplary embodiments with reference to the attached drawings in which:

FIG. 1 illustrates an embodiment of a power system using a series-parallel conversion power device;

FIG. 2 illustrates an embodiment of a series-parallel conversion power device;

FIG. 3 illustrates a circuit for the series-parallel conversion power device;

FIG. 4 illustrates another embodiment of a series-parallel conversion power device;

FIG. 5 illustrates another embodiment of a series-parallel conversion power device;

FIG. 6 illustrates another embodiment of a series-parallel conversion power device; and

FIG. 7 illustrates another embodiment of a series-parallel conversion power device.

### DETAILED DESCRIPTION

Example embodiments will now be described more fully hereinafter with reference to the accompanying drawings; however, they may be embodied in different forms and should not be construed as limited to the embodiments set forth herein. Rather, these embodiments are provided so that this disclosure will be thorough and complete, and will fully convey exemplary implementations to those skilled in the art. The embodiments may be combined to form additional embodiments. Like reference numerals refer to like elements throughout.

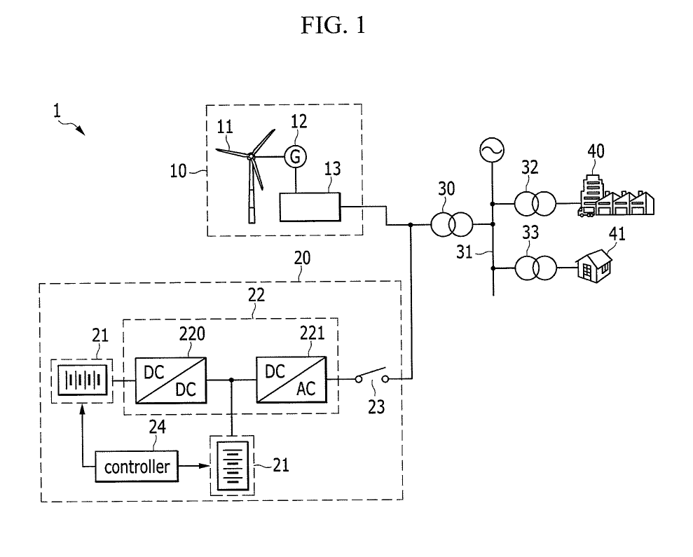

FIG. 1 illustrates an example of a power system 1 including a series-parallel conversion power device 21. The power system 1 includes a wind power system 10, a cell system 20, and a transformer 30.

The wind power system 10 converts wind power energy to electricity. The wind power system 10 includes a windmill 11, an electric generator 12, and a power converter 13. The windmill 11 rotates by wind power and transfers torque to an electric generator 12. The electric generator 12 is driven by the transferred torque, thus generating electricity. The power converter 13 converts power generated by the electric generator 12 to predetermined AC power. The power converter 13 outputs the converted power to the transformer 30.

The cell system 20 includes the series-parallel conversion power device 21, a Power Conditioning Subsystem (PCS) 22, a circuit breaker 23, and a control unit 24. The series-parallel conversion power device 21 includes a plurality of cells, and discharges power accumulated in the plurality of cells. The series-parallel conversion power device 21 is charged by power generated by the wind power system 10.

The PCS 22 converts DC power discharged by the series-parallel conversion power device 21 to AC power. The PCS 22 includes a DC/DC converter 220 and a DC/AC converter 221. The DC/DC converter 220 converts the voltage of the DC power discharged by the series-parallel conversion power device 21 to a predetermined voltage, and supplies the DC/AC converter 221 with the DC power converted to the predetermined voltage. The DC/AC converter 221 converts the DC power supplied by the DC/DC converter 220 to AC power. The circuit breaker 23 connects the DC/AC converter 221 and the wind power system 10, and the DC/AC converter 221 and the transformer 30, and blocks connections between them.

When the circuit breaker 23 is in an on state, the PCS 22 converts power discharged by the series-parallel conversion power device 21 to AC power and outputs the converted power to the transformer 30. In another embodiment, the PCS 22 converts power generated by the wind power system 10 to DC power and charges the series-parallel conversion power device 21 using the DC power. When the circuit breaker 23 is in an off state, the charging and discharging of the series-parallel conversion power device 21 are not performed.

The transformer 30 converts the voltage of the AC power, converted by the DC/AC converter 221, and the voltage of the AC power, converted by the power converter 13, to a predetermined voltage of AC power. The transformer 30 supplies the converted voltage to an AC system 31. The transformer 30 may be a transformer, for example. Power supplied to the AC system 31 is supplied to a factory 40 or a home 41 via transformers 32 and 33.

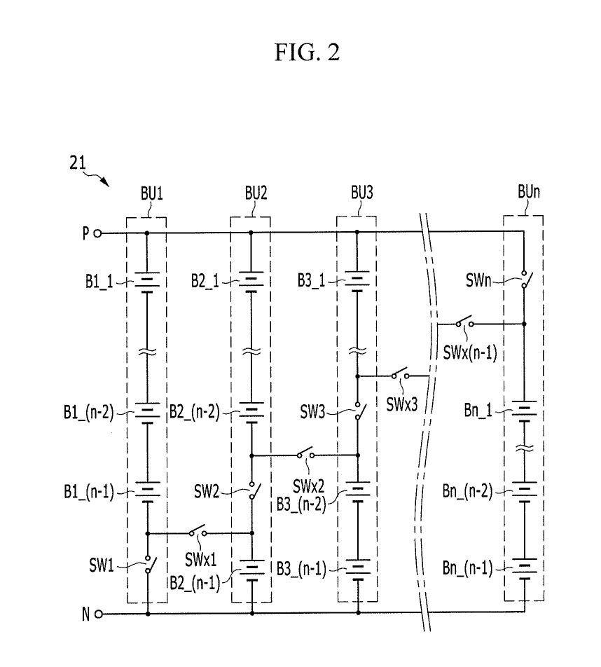

FIG. 2 illustrates an embodiment of the series-parallel conversion power device 21. As illustrated in FIG. 2, the series-parallel conversion power device 21 may includes n (n is an integer of 3 or more) cell series connection units BU (e.g., a cell series connection unit BU1, a cell series connection unit BU2, . . . , a cell series connection unit BUn), and n−1 inter-unit connection switches SWx (e.g., an inter-unit connection switch SWx1, an inter-unit connection switch SWx2, . . . , an inter-unit connection switch SWx(n−1).

The cell series connection units BU1-Bun are installed in parallel between a positive electrode charging/discharging terminal P and a negative electrode charging/discharging terminal N. The cell series connection unit BU1 includes n−1 cells B1 (e.g., a cell B1_1, . . . , a cell B_1 (n−2), and a cell B1_(n−1)), and an intra-unit switch SW1. The cell B1_1 has a positive electrode terminal connected to the positive electrode charging/discharging terminal P. The cell B1_(n−1) has a negative electrode terminal connected to the intra-unit switch SW1.

The intra-unit switch SW1 has a first terminal connected to the negative electrode terminal of the cell B1_(n−1). The intra-unit switch SW1 has a second terminal connected to the negative electrode charging/discharging terminal N.

As described above, in the cell series connection unit BU1, the cell B1_{—}1, . . . , the cell B1_(n−2), the cell B1_(n−1), and the intra-unit switch SW1 are sequentially connected in series from the positive electrode charging/discharging terminal P.

The cell series connection unit BUk of a k (1=k=n) column includes n−1 cells Bk (e.g., a cell Bk_1, . . . , a cell Bk_(n−2), and a cell Bk_(n−1)), and an intra-unit switch SWk. The cell Bk_1 has a positive electrode terminal connected to the positive electrode charging/discharging terminal P. The cell Bk_(n−1) has a negative electrode terminal connected to the negative electrode charging/discharging terminal N.

The intra-unit switch SWk is connected in series between a (k−1)-th cell from the negative electrode charging/discharging terminal N and a k-th cell.

The cell series connection unit BUn includes n−1 cells Bn (e.g., a cell Bn_{—}1, . . . , a cell Bn_(n−2), and a cell Bn_(n−1)), and an intra-unit switch SWn. The intra-unit switch SWn has a first terminal connected to the positive electrode charging/discharging terminal P. The intra-unit switch SWn has a second terminal connected to the positive electrode terminal of the cell Bn_1. The cell Bn_(n−1) has a negative electrode terminal connected to the negative electrode charging/discharging terminal N.

As described above, in the cell series connection unit BUn, the intra-unit switch SWn, the cell Bn_1, . . . , the cell Bn_(n−2), and the cell Bn_(n−1) are sequentially connected in series from the positive electrode charging/discharging terminal P.

The inter-unit connection switches SWx1-SWx(n−1) are connected between the cell series connection units BU1-BUn. The inter-unit connection switch SWx1 is connected between the first terminal of the intra-unit switch SW1 and the second terminal of an intra-unit switch SW2. The inter-unit connection switch SWxk of a k-th column is connected between the first terminal of the intra-unit switch SWk and the second terminal of a intra-unit switch SW(k+1) of a (k+1)-th column.

The switching operations of the switch inter-unit connection switches SWx (e.g., the inter-unit connection switch SWx1, the inter-unit connection switch SWx2, . . . , the inter-unit connection switch SWx(n−1)) and the intra-unit switches SW (i.e., the intra-unit switch SW1, the intra-unit switch SW2, . . . , the intra-unit switch SWn) are described below.

The control unit 24 controls the on state and off state of the inter-unit connection switch SWx and intra-unit switch SW. The control unit 24 controls the intra-unit switches SW1-SWn to be in an on state and simultaneously control the inter-unit connection switches SWx1-SWx(n−1) to be in an off state. For example, the control unit 24 controls the connection of the cell B (the cell B1_1-(Bn_(n−1)) so that it has an n−1 series and n parallel state. Accordingly, loads are uniformly distributed to the cell B with respect to the charging and discharging of the series-parallel conversion power device 21.

As described above, the control unit 24 controls the connection of the cell B to have an n−1 series and n parallel state or an n series and n−1 parallel state. In this case, the switching of the connection of the cell B is performed based on the output voltage of the cell B. For example, if the output voltage of the cell B is lower than a predetermined threshold, the connection of the cell B becomes the n series and n−1 parallel state.

Furthermore, if the output voltage of the cell B is higher than a predetermined threshold, the connection of the cell B becomes the n−1 series and n parallel state.

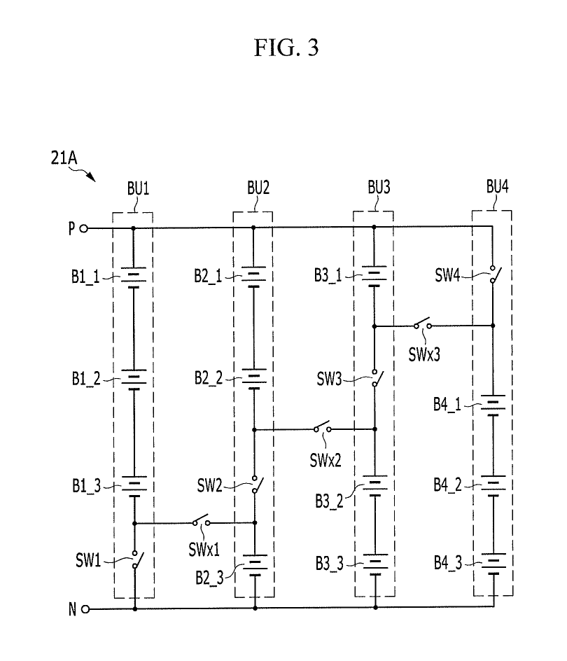

FIG. 3 illustrates an example configuration of the series-parallel conversion power device 21A in the case where n=4. As illustrated in FIG. 3, the series-parallel conversion power device 21A includes four cell series connection units BU (e.g., cell series connection units BU1-BU4) and three inter-unit connection switches SWx (e.g., inter-unit connection switches SWx1-SWx3).

The cell series connection units BU are installed between a positive electrode charging/discharging terminal P and a negative electrode charging/discharging terminal N. The cell series connection units BU are connected in parallel. The cell series connection unit BU1 may include three cells B1 (e.g., cells B1_1-B1_3) and an intra-unit switch SW1. The cell B1_1 has a positive electrode terminal connected to the positive electrode charging/discharging terminal P. The cell B1_2 has a positive electrode terminal connected to the negative electrode terminal of the cell B1_1 and has a negative electrode terminal connected to the positive electrode terminal of the cell B1_3. The cell B1_3 has a negative electrode terminal connected to the intra-unit switch SW1.

The intra-unit switch SW1 has a first terminal connected to the negative electrode terminal of the cell B1_3. The intra-unit switch SW1 has a second terminal connected to the negative electrode charging/discharging terminal N. As described above, in the cell series connection unit BU1 the cell B1_1, the cell B1_2, the cell B1_3, and the intra-unit switch SW1 are sequentially connected in series from the positive electrode charging/discharging terminal P.

The cell series connection unit BU2 may include three cells B2 (e.g., cells B2_1-B2_3) and an intra-unit switch SW2. The cell B2_1 has a positive electrode terminal connected to the positive electrode charging/discharging terminal P. The cell B2_2 has a positive electrode terminal connected to the negative electrode terminal of the cell B2_1 and has a negative electrode terminal connected to the first terminal of the intra-unit switch SW2. The cell B2_3 has a positive electrode terminal connected to the second terminal of the intra-unit switch SW2 and has a negative electrode terminal connected to the negative electrode charging/discharging terminal N.

The intra-unit switch SW2 is connected in series between the cell B2_3 (e.g., the first cell from the negative electrode charging/discharging terminal N) and the cell B2_2 (e.g., the second cell from the negative electrode charging/discharging terminal N).

As described above, in the cell series connection unit BU2, the cell B2_1, the cell B2_2, the intra-unit switch SW2, and the cell B2_3 are sequentially connected in series from the positive electrode charging/discharging terminal P. The cell series connection unit BU3 may include three cells B3 (e.g., cells B3_1-B3_3) and an intra-unit switch SW3. The cell B3_1 has a positive electrode terminal connected to the positive electrode charging/discharging terminal P and has a negative electrode terminal connected to the first terminal of the intra-unit switch SW3. The cell B3_2 has a positive electrode terminal connected to the second terminal of the intra-unit switch SW3 and has a negative electrode terminal connected to the positive electrode terminal of the cell B3_3. The cell B3_3 has a negative electrode terminal connected to the negative electrode charging/discharging terminal N.

The intra-unit switch SW3 is connected in series between the cell B3_2 (e.g., the second cell from the negative electrode charging/discharging terminal N) and the cell B3_1 (e.g., the third cell from the negative electrode charging/discharging terminal N).

As described above, in the cell series connection unit BU3, the cell B3_1, the intra-unit switch SW3, the cell B3_2, and the cell B3_3 are sequentially connected in series from the positive electrode charging/discharging terminal P. The cell series connection unit BU4 may include three cells B4 (e.g., cells B4_1-B4_3) and an intra-unit switch SW4. The cell B4_1 has a positive electrode terminal connected to the second terminal of the intra-unit switch SW4 and has a negative electrode terminal connected to the positive electrode terminal of the cell B4_2. The cell B4_2 has a negative electrode terminal connected to the positive electrode terminal of the cell B4_3. The cell B4_3 has a negative electrode terminal connected to the negative electrode charging/discharging terminal N.

The intra-unit switch SW4 has a first terminal connected to the positive electrode charging/discharging terminal P and has a second terminal connected to the positive electrode terminal of the cell B4_1. As described above, in the cell series connection unit BU4, the intra-unit switch SW4, the cell B4_1, the cell B4_2, and the cell B4_3 are sequentially connected in series from the positive electrode charging/discharging terminal P. The inter-unit connection switches SWx1-SWx3 are connected between the cell series connection units BU1-BUn.

The inter-unit connection switch SWx1 is connected between the first terminal of the intra-unit switch SW1 and the second terminal of the intra-unit switch SW2.

The inter-unit connection switch SWx2 is connected between the first terminal of the intra-unit switch SW2 and the second terminal of the intra-unit switch SW3.

The inter-unit connection switch SWx3 is connected between the first terminal of the intra-unit switch SW3 and the second terminal of the intra-unit switch SW4.

The control unit 24 controls the on state and off state of the inter-unit connection switch SWx and the intra-unit switch SW.

Thus, the control unit 24 controls the connection of the cells B1_1-B4_3 so that it has a 3 series and 4 parallel state or a 4 series and 3 parallel state.

Operation of the 3 series and 4 parallel state and 4 series and 3 parallel state of the series-parallel conversion power device 21A will now be described. The control unit 24 controls the intra-unit switches SW1-SW4 to have an on state and simultaneously controls the inter-unit connection switches SWx1-SWx3 to have an off state. In this case, a current path between the positive electrode charging/discharging terminal P and negative electrode charging/discharging terminal N of the series-parallel conversion power device 21A upon charging and discharging has the following four current paths.

The first path is the path of the positive electrode charging/discharging terminal P, the cell B1_1, the cell B1_2, the cell B1_3, the intra-unit switch SW1, and the negative electrode charging/discharging terminal N.

The second path is the path of the positive electrode charging/discharging terminal P, the cell B2_1, the cell B2_2, the intra-unit switch SW2, the cell B2_3, and the negative electrode charging/discharging terminal N.

The third path is the path of the positive electrode charging/discharging terminal P, the cell B3_1, the intra-unit switch SW3, the cell B3_2, the cell B3_3, and the negative electrode charging/discharging terminal N.

The fourth path is the path of the positive electrode charging/discharging terminal P, the intra-unit switch SW4, the cell B4_1, the cell B4_2, the cell B4_3, and the negative electrode charging/discharging terminal N.

An order within the first to fourth paths is an order of current paths upon charging. An order of current paths upon discharging is an opposite order of the first to fourth paths. Accordingly, loads are uniformly distributed to the cells B1_1-B3_3 with respect to charging and discharging of the series-parallel conversion power device 21A.

Operation of the 4 series and 3 parallel state of the series-parallel conversion power device 21A is now explained. The control unit 24 controls the intra-unit switches SW1-SW4 to have an off state and simultaneously controls the inter-unit connection switch SWx1 to the inter-unit connection switch SWx3 to have an on state. In this case, a current path between the positive electrode charging/discharging terminal P and negative electrode charging/discharging terminal N of the series-parallel conversion power device 21A upon charging and discharging has the following three current paths.

The first path is the path of the positive electrode charging/discharging terminal P, the cell B1_1, the cell B1_2, the cell B1_3, the inter-unit connection switch SWx, the cell B2_3, and the negative electrode charging/discharging terminal N.

The second path is the path of the positive electrode charging/discharging terminal P, the cell B2_1, the cell B2_2, the inter-unit connection switch SWx2, the cell B3_2, the cell B3_3, and the negative electrode charging/discharging terminal N.

The third path is the path of the positive electrode charging/discharging terminal P, the cell B3_1, the inter-unit connection switch SWx3, the cell B4_1, the cell B4_2, the cell B4_3, and the negative electrode charging/discharging terminal N.

An order within the first to third paths is an order of current paths upon charging. An order of current paths upon discharging is an opposite order of the first to third paths. Accordingly, loads are uniformly distributed to the cells B1_1-B3_3 with respect to charging and discharging of the series-parallel conversion power device 21A.

In another type of series-parallel conversion power device which has been proposed, the output voltage range of the series-parallel conversion power device corresponds to the range of a change of a cell. For example, if a voltage range of a cell is 50-100%, an output voltage range of the series-parallel conversion power device is 50-100%. However, in accordance with one embodiment of the series-parallel conversion power device 21, switching is performed between the n−1 series and n parallel state and the n series and n−1 parallel state. Accordingly, the range of output voltage may be suppressed to a predetermined range, e.g., 67-100%.

For example, when n=4, if the cell voltage of the cells B1_1-B3_3 is a predetermined threshold or less (e.g., 50% or less), the configuration of the series-parallel conversion power device is changed to the 4 series and 3 parallel state. Thus, the output voltage of the series-parallel conversion power device may be raised 67%.

As described above, in the series-parallel conversion power device 21 in of the present exemplary embodiment, the cell series connection units BU1-BUn in which the n−1 cells and one intra-unit switch are connected in series are disposed in parallel in n columns between the positive electrode charging/discharging terminal P and the negative electrode charging/discharging terminal N. Also, the inter-unit connection switches SWx1-SWx(n−1) are installed between the cell series connection units BU1-BUn of the n columns.

In the cell series connection unit of a k (1=k=n)-th column, the intra-unit switches SW1-SWn have the first terminals connected to the negative electrode terminal of a k-th cell from the negative electrode charging/discharging terminal N and have the second terminals connected to a (k−1)-th cell positive electrode terminal from the negative electrode charging/discharging terminal N.

The inter-unit connection switches SWx1-SWx(n−1) are connected between the first terminal of a k-th column intra-unit switch and the second terminal of a (k+1)-th column intra-unit switch. Accordingly, the uniformity of loads on respective cells may be maintained, combinations of series and parallels (e.g., n series and n+1 parallel state and the n+1 series and n parallel state) may switch, and a change in output voltage may be suppressed.

Furthermore, the number of switches may be reduced compared to the number of cells B used. Accordingly, the series-parallel conversion power device may have a small size and lower price compared to other devices which have been proposed.

Furthermore, in all the current paths upon charging and discharging, the number of switches through which a current passes is only one. For this reason, loss of current passing through switches may be reduced or minimized, which contributes to low loss for the series-parallel conversion power device 21.

In the aforementioned exemplary embodiment, the intra-unit switch SW and the inter-unit connection switch SWx may be a mechanical switch or a semiconductor switch. For example, the aforementioned exemplary embodiment is not limited to the type of switch of the intra-unit switch SW and the inter-unit connection switch SWx.

Furthermore, in the aforementioned exemplary embodiment, the cell B may be applied to both the primary cell and the secondary cell. For example, the aforementioned exemplary embodiment is not limited to the type of cell B.

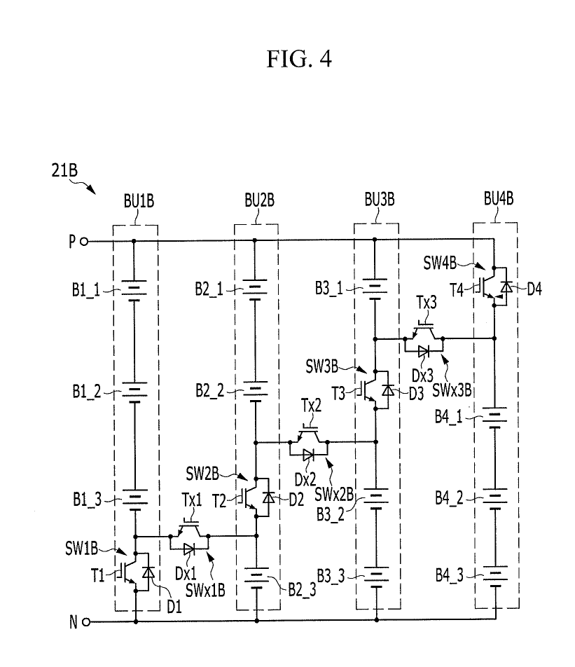

FIG. 4 illustrates another embodiment of a series-parallel conversion power device 21B for a power system. In the present exemplary embodiment, the intra-unit switch SW of the aforementioned embodiment is substituted with an intra-unit switch SWB, and the inter-unit connection switch SWx thereof is substituted with an inter-unit connection switch SWxB. The illustrative case where n=4 is described.

As illustrated in FIG. 4, the series-parallel conversion power device 21B may include four cell series connection units BU1B-BU4B and three inter-unit connection switches SWx1B-SWx3B.

The cell series connection units BU1B-BU4B are installed in parallel between a positive electrode charging/discharging terminal P and a negative electrode charging/discharging terminal N. The cell series connection unit BU1B may include three cells B1_1-B1_3 and an intra-unit switch SW1B. The cell B1_1 has a positive electrode terminal connected to the positive electrode charging/discharging terminal P. The cell B1_2 has a positive electrode terminal connected to the negative electrode terminal of the cell B1_1 and has a negative electrode terminal connected to the positive electrode terminal of the cell B1_3. The cell B1_3 has a negative electrode terminal connected to the intra-unit switch SW1B.

The intra-unit switch SW1B may include a self-commutated semiconductor switch T1 and a diode D1. The self-commutated semiconductor switch T1 may be implemented using a bipolar transistor, a Metal-Oxide-Semiconductor Field-Effect Transistor (MOSFET), or an Insulated Gate Bipolar Transistor (IGBT), for example. The diode D1 is reversely connected in parallel (in reverse parallel) to the self-commutated semiconductor switch T1. The intra-unit switch SW1B has a first terminal connected to the negative electrode terminal of the cell B1_3. The intra-unit switch SW1B has a second terminal connected to the negative electrode charging/discharging terminal N.

As described above, in the cell series connection unit BU1B, the cell B1_1, the cell B1_2, the cell B1_3, and the intra-unit switch SW1B are sequentially connected in series from the positive electrode charging/discharging terminal P.

The cell series connection unit BU2B may include three cells B2_1-2_3 and an intra-unit switch SW2B. The cell B2_1 has a positive electrode terminal connected to the positive electrode charging/discharging terminal P. The cell B2_2 has a positive electrode terminal connected to the negative electrode terminal of the cell B2_1 and has a negative electrode terminal connected to the first terminal of the intra-unit switch SW2B. The cell B2_3 has a positive electrode terminal connected to the second terminal of the intra-unit switch SW2B and has a negative electrode terminal connected to the negative electrode charging/discharging terminal N.

The intra-unit switch SW2B may include a self-commutated semiconductor switch T2 and a diode D2. The self-commutated semiconductor switch T2 may be implemented using a bipolar transistor, a MOSFET, or an IGBT, for example. The diode D2 is reversely connected in parallel to self-commutated semiconductor switch T2. The intra-unit switch SW2B is connected in series between the cell B2_3, that is, the first cell from the negative electrode charging/discharging terminal N, and the cell B2_2, that is, the second cell from the negative electrode charging/discharging terminal N.

As described above, in the cell series connection unit BU2B, the cell B2_1, the cell B2_2, the intra-unit switch SW2B, and the cell B2_3 are sequentially connected in series from the positive electrode charging/discharging terminal P.

The cell series connection unit BU3B may include three cells B3_1-B3_3 and an intra-unit switch SW3B. The cell B3_1 has a positive electrode terminal connected to the positive electrode charging/discharging terminal P and has a negative electrode terminal connected to the first terminal of the intra-unit switch SW3B. The cell B3_2 has a positive electrode terminal connected to the second terminal of the intra-unit switch SW3B and has a negative electrode terminal connected to the positive electrode terminal of the cell B3_3. The cell B3_3 has a negative electrode terminal connected to the negative electrode charging/discharging terminal N.

The intra-unit switch SW3B may include a self-commutated semiconductor switch T3 and a diode D3. The self-commutated semiconductor switch T3 may be implemented using a bipolar transistor, a MOSFET, or an IGBT, for example. The diode D3 is reversely connected in parallel to the self-commutated semiconductor switch T3. The intra-unit switch SW3B is connected in series between the cell B3_2, that is, the second cell from the negative electrode charging/discharging terminal N, and the cell B3_1, that is, the third cell from the negative electrode charging/discharging terminal N.

As described above, in the cell series connection unit BU3B, the cell B3_1, the intra-unit switch SW3B, the cell B3_2, and the cell B3_3 are sequentially connected in series from the positive electrode charging/discharging terminal P.

The cell series connection unit BU4B includes three cells B4_1-B4_3 and an intra-unit switch SW4B. The cell B4_1 has a positive electrode terminal connected to the second terminal of the intra-unit switch SW4B and has a negative electrode terminal connected to the positive electrode terminal of the cell B4_2. The cell B4_2 has a negative electrode terminal connected to positive electrode terminal of the cell B4_3. The cell B4_3 has a negative electrode terminal connected to the negative electrode charging/discharging terminal N.

The intra-unit switch SW4B may include a self-commutated semiconductor switch T4 and a diode D4. The self-commutated semiconductor switch T4 may be implemented using a bipolar transistor, a MOSFET, or an IGBT, for example. The diode D4 is reversely connected in parallel to the self-commutated semiconductor switch T4. The intra-unit switch SW4B has a first terminal connected to the positive electrode charging/discharging terminal P and has a second terminal connected to the positive electrode terminal of the cell B4_1.

As described above, in the cell series connection unit BU4B, the intra-unit switch SW4B, the cell B4_1, the cell B4_2, and the cell B4_3 are sequentially connected in series from the positive electrode charging/discharging terminal P.

The inter-unit connection switches SWx1B-SWx3B are connected between the cell series connection units BU1B-BU4B. The inter-unit connection switch SWx1B may include a self-commutated semiconductor switch Tx1 and a diode Dx1. The self-commutated semiconductor switch Tx1 may be implemented using a bipolar transistor, a MOSFET, or an IGBT, for example. The diode Dx1 is reversely connected in parallel to the self-commutated semiconductor switch Tx1.

The inter-unit connection switch SWx B is connected between the first terminal of intra-unit switch SW1B and the second terminal of the intra-unit switch SW2B. The inter-unit connection switch SWx2B may include a self-commutated semiconductor switch Tx2 and a diode Dx2. The self-commutated semiconductor switch Tx2 may be implemented using a bipolar transistor, a MOSFET, or an IGBT, for example. The diode Dx2 is reversely connected in parallel to the self-commutated semiconductor switch Tx2. The inter-unit connection switch SWx2B is connected between the first terminal of the intra-unit switch SW2B and the second terminal of the intra-unit switch SW3B.

The inter-unit connection switch SWx3B may include a self-commutated semiconductor switch Tx3 and a diode Dx3. The self-commutated semiconductor switch Tx3 may be implemented using a bipolar transistor, a MOSFET, or an IGBT, for example. The diode Dx3 is reversely connected in parallel to the self-commutated semiconductor switch Tx3. The inter-unit connection switch SWx3B is connected between the first terminal of the intra-unit switch SW3B and the second terminal of the intra-unit switch SW4B.

The control unit 24 controls the on state and off state of the inter-unit connection switches SWx1B-SWx3B and the intra-unit switch SWB. For example, the control unit 24 controls the connection of the cells B1_1-B4_3 to have a 3 series and 4 parallel state or a 4 series and 3 parallel state.

Operation of the 3 series and 4 parallel state and the 4 series and 3 parallel state when the charging and discharging of the series-parallel conversion power device 21B are described below. For example, operation for supplying external power to the series-parallel conversion power device 21B (e.g., an operation when the charging of the series-parallel conversion power device 21B is performed) is described.

The control unit 24 controls all of the intra-unit switches SW1B-SW4B and the inter-unit connection switches SWx1B-SWx3B so that they become an off state. In this case, a current path between the positive electrode charging/discharging terminal P and negative electrode charging/discharging terminal N of the series-parallel conversion power device 21B upon charging has the following three paths.

The first path is the path of the positive electrode charging/discharging terminal P, the cell B1_1, the cell B1_2, the cell B1_3, the diode Dx1, the cell B2_3, and the negative electrode charging/discharging terminal N.

The second path is the path of the positive electrode charging/discharging terminal P, the cell B2_1, the cell B2_2, the diode Dx2, the cell B3_2, the cell B3_3, and the negative electrode charging/discharging terminal N.

The third path is the path of the positive electrode charging/discharging terminal P, the cell B3_1, the diode Dx3, the cell B4_1, the cell B4_2, the cell B4_3, and the negative electrode charging/discharging terminal N.

As described above, the series-parallel conversion power device 21B performs a charging operation in the state in which the connection of the cell B has the 4 series and 3 parallel state. In this case, loads may be uniformly distributed to the cells B due to the symmetricity of circuits.

If the cell B continues to be charged when the connection of the cell B is the 4 series and 3 parallel state and thus a cell voltage thereof becomes a predetermined threshold or more, the control unit 24 controls all of the self-commutated semiconductor switches T1-T4 so that they become an on state. In this case, a current path between the positive electrode charging/discharging terminal P and negative electrode charging/discharging terminal N of the series-parallel conversion power device 21B has the following four paths.

The first path is the path of the positive electrode charging/discharging terminal P, the cell B1_1, the cell B1_2, the cell B1_3, the self-commutated semiconductor switch T1, and the negative electrode charging/discharging terminal N.

The second path is the path of the positive electrode charging/discharging terminal P, the cell B2_1, the cell B2_2, the self-commutated semiconductor switch T2, the cell B2_3, and the negative electrode charging/discharging terminal N.

The third path is the path of the positive electrode charging/discharging terminal P, the cell B3_1, the self-commutated semiconductor switch T3, the cell B3_2, the cell B3_3, and the negative electrode charging/discharging terminal N.

The fourth path is the path of the positive electrode charging/discharging terminal P, the self-commutated semiconductor switch T4, the cell B4_1, the cell B4_2, the cell B4_3, and the negative electrode charging/discharging terminal N.

As described above, the series-parallel conversion power device 21B performs a charging operation when the connection of the cell B is in the 3 series and 4 parallel state. In this case, loads may be uniformly distributed to the cells B as a result of the circuit symmetry. Also, a voltage between the positive electrode charging/discharging terminal P and the negative electrode charging/discharging terminal N can be reduced about 3/4 times by changing the connection of the cells of the series-parallel conversion power device 21B from the 4 series and 3 parallel state to the 3 series and 4 parallel.

)peration for supplying power from the series-parallel conversion power device 21B to the an external device (e.g., peration of the series-parallel conversion power device 21B upon discharging) is described below.

The control unit 24 controls all of the intra-unit switches SW1B-SW4B and the inter-unit connection switches SWx B-SWx3B so that they become an off state. In this case, a current path between the positive electrode charging/discharging terminal P and negative electrode charging/discharging terminal N of the series-parallel conversion power device 21B upon discharging has the following four paths.

The first path is the path of the negative electrode charging/discharging terminal N, the diode D1, the cell B1_3, the cell B1_2, the cell B1_1, and the positive electrode charging/discharging terminal P.

The second path is the path of the negative electrode charging/discharging terminal N, the cell B2_3, the diode D2, the cell B2_2, the cell B2_1, and the negative electrode charging/discharging terminal N.

The third path is the path of the negative electrode charging/discharging terminal N, the cell B3_3, the cell B3_2, the diode D3, the cell B3_1, and the positive electrode charging/discharging terminal P.

The fourth path is the path of the negative electrode charging/discharging terminal N, the cell B4_3, the cell B4_2, the cell B4_1, the diode D4, and the positive electrode charging/discharging terminal P.

As described above, the series-parallel conversion power device 21B performs a discharging operation when the connection of the cell B is the 3 series and 4 parallel state. In this case, loads may be uniformly distributed to the cells B due to circuit symmetry.

If the cell B continues to be charged when the connection of the cell B is the 3 series and 4 parallel state and thus a cell voltage thereof becomes less than a predetermined threshold, the control unit 24 controls all of the self-commutated semiconductor switches Tx1-Tx4 to be in the on state.

In this case, a current path between the positive electrode charging/discharging terminal P and negative electrode charging/discharging terminal N of the series-parallel conversion power device 21B upon discharging has the following three paths.

The first path is the path of the negative electrode charging/discharging terminal N, the cell B2_3, the self-commutated semiconductor switch Tx1, the cell B1_3, the cell B1_2, the cell B1_1, and the positive electrode charging/discharging terminal P.

The second path is the path of the negative electrode charging/discharging terminal N, the cell B3_3, the cell B3_2, the self-commutated semiconductor switch Tx2, the cell B2_2, the cell B2_1, and the negative electrode charging/discharging terminal N.

The third path is the path of the negative electrode charging/discharging terminal N, the cell B4_3, the cell B4_2, the cell B4_1, the self-commutated semiconductor switch Tx3, the cell B3_1, and the positive electrode charging/discharging terminal P.

As described above, the series-parallel conversion power device 21B performs a discharging operation when the connection of the cell B is in the 4 series and 3 parallel state. In this case, loads may be uniformly distributed to the cells B due to circuit symmetry. Furthermore, a voltage between the positive electrode charging/discharging terminal P and the negative electrode charging/discharging terminal N may be raised about 4/3 times by changing the connection of the cells of the series-parallel conversion power device 21B from the 3 series and 4 parallel state to the 4 series and 3 parallel state.

As described above, in the series-parallel conversion power device 21B of the present exemplary embodiment, the intra-unit switches SW1-SW4 of the first exemplary embodiment have been substituted with the intra-unit switches SW1B-SW4B and the inter-unit connection switches SWx1-SWx3 have been substituted with the inter-unit connection switches SWx1B-SWx3B. Furthermore, the intra-unit switches SW1B-SW4B and the inter-unit connection switches SWx1B-SWx3B include the self-commutated semiconductor switches and the diodes reversely connected in parallel to the respective self-commutated semiconductor switches. Accordingly, the present exemplary embodiment has the same effects as the first exemplary embodiment.

Furthermore, the series-parallel conversion power device 21B of the present exemplary embodiment has been configured as described above. If switching is performed between the 3 series and 4 parallel state and the 4 series and 3 parallel state, when the self-commutated semiconductor switch is in the on state, a current is commutated from a path on the diode side to a path on the self-commutated semiconductor switch side. Accordingly, when switching is performed between the n series and n+1 parallel state and the n+1 series and n parallel state, a smooth switching operation can be performed without temporary breaking.

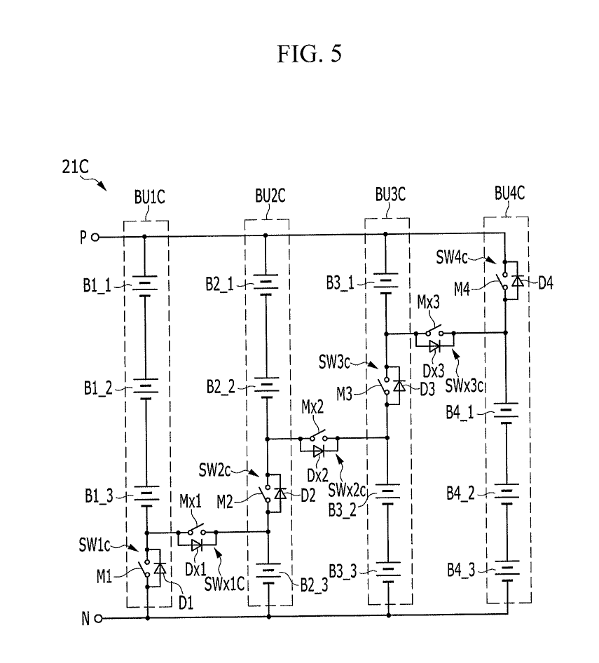

FIG. 5 illustrates another embodiment of a series-parallel conversion power device 21C for a power system. In the present exemplary embodiment, the intra-unit switch SW of the first exemplary embodiment is substituted with an intra-unit switch SWC, and the inter-unit connection switch SWx is substituted with an inter-unit connection switch SWxC. In the present exemplary embodiment, the illustrative case of n=4 is described.

As illustrated in FIG. 5, the series-parallel conversion power device 21C may include four cell series connection units BU1C-BU4C and three inter-unit connection switches SWx1C-SWx3C. The cell series connection units BU1C-BU4C are installed in parallel between a positive electrode charging/discharging terminal P and a negative electrode charging/discharging terminal N. The cell series connection unit BU1C may include three cells B1_1-B1_3 and an intra-unit switch SW1C.

The cell B1_1 has a positive electrode terminal connected to the positive electrode charging/discharging terminal P. The cell B1_2 has a positive electrode terminal connected to the negative electrode terminal of the cell B1_1 and has a negative electrode terminal connected to the positive electrode terminal of the cell B1_3. The cell B1_3 has a negative electrode terminal connected to the intra-unit switch SW1C.

The intra-unit switch SW1C may include a mechanical switch M1 and a diode D1. The diode D1 is connected in parallel to the mechanical switch M1. In the intra-unit switch SW1C, the cathode side of the diode D1 is assumed to be a first terminal, and the anode side thereof is assumed to be a second terminal. The intra-unit switch SW1C has a first terminal connected to the negative electrode terminal of the cell B1_3. The intra-unit switch SW1C has a second terminal connected to the negative electrode charging/discharging terminal N.

As described above, in the cell series connection unit BU1C, the cell B1_1, the cell B1_2, the cell B1_3, and the intra-unit switch SW1C are sequentially connected in series from the positive electrode charging/discharging terminal P.

The cell series connection unit BU2C may include three cells B2_1-B2_3 and an intra-unit switch SW2C. The cell B2_1 has a positive electrode terminal connected to the positive electrode charging/discharging terminal P. The cell B2_2 has a positive electrode terminal connected to the negative electrode terminal of the cell B2_1 and has a negative electrode terminal connected to the first terminal of the intra-unit switch SW2C. The cell B2_3 has a positive electrode terminal connected to the second terminal of the intra-unit switch SW2C and has a negative electrode terminal connected to the negative electrode charging/discharging terminal N.

The intra-unit switch SW2C may include a mechanical switch M2 and a diode D2. The diode D2 is connected in parallel to the mechanical switch M2. In the intra-unit switch SW2C, the cathode side of the diode D2 is assumed to be a first terminal, and the anode side of the diode D2 is assumed to be a second terminal. The intra-unit switch SW2C is connected in series between the cell B2_3, that is, the first cell from the negative electrode charging/discharging terminal N, and the cell B2_2, that is, the second cell from the negative electrode charging/discharging terminal N.

As described above, in the cell series connection unit BU2C, the cell B2_1, the cell B2_2, the intra-unit switch SW2C, and the cell B2_3 are sequentially connected in series from the positive electrode charging/discharging terminal P.

The cell series connection unit BU3C may include three cells B3_1-B3_3 and an intra-unit switch SW3C. The cell B3_1 has a positive electrode terminal connected to the positive electrode charging/discharging terminal P and has a negative electrode terminal connected to the first terminal of the intra-unit switch SW3C. The cell B3_2 has a positive electrode terminal connected to the second terminal of the intra-unit switch SW3C and has a negative electrode terminal connected to the positive electrode terminal of the cell B3_3. The cell B3_3 has a negative electrode terminal connected to the negative electrode charging/discharging terminal N.

The intra-unit switch SW3C may include a mechanical switch M3 and a diode D3. The diode D3 is connected in parallel to the mechanical switch M3. In the intra-unit switch SW3C, the cathode side of the diode D3 is assumed to be a first terminal, and the anode side of the diode D3 is assumed to be a second terminal. The intra-unit switch SW3C is connected in series between the cell B3_2, that is, the second cell from the negative electrode charging/discharging terminal N, and the cell B3_1, that is, the third cell from the negative electrode charging/discharging terminal N.

As described above, in the cell series connection unit BU3C, the cell B3_1, the intra-unit switch SW3C, the cell B3_2, and the cell B3_3 are sequentially connected in series from the positive electrode charging/discharging terminal P.

The cell series connection unit BU4C may include three cells B4_11-B4_3 and an intra-unit switch SW4C. The cell B4_1 has a positive electrode terminal connected to the second terminal of the intra-unit switch SW4C and has a negative electrode terminal connected to the positive electrode terminal of the cell B4_2. The cell B4_2 has a negative electrode terminal connected to the positive electrode terminal of the cell B4_3. The cell B4_3 has a negative electrode terminal connected to the negative electrode charging/discharging terminal N.

The intra-unit switch SW4C may include a mechanical switch M4 and a diode D4. The diode D4 is connected in parallel to the mechanical switch M4. In the intra-unit switch SW4C, the cathode side of the diode D4 is assumed to be a first terminal, and the anode side of the diode D4 is assumed to be a second terminal. The intra-unit switch SW4C has a first terminal connected to the positive electrode charging/discharging terminal P and has a second terminal connected to the positive electrode terminal of the cell B4_1.

As described above, in the cell series connection unit BU4C, the intra-unit switch SW4C, the cell B4_1, the cell B4_2, and the cell B4_3 are sequentially connected in series from the positive electrode charging/discharging terminal P.

The inter-unit connection switches SWx1C-SWx3C are connected between the cell series connection units BU1C-BU4C. The inter-unit connection switch SWx1C may include a mechanical switch Mx1 and a diode Dx1. The diode Dx1 is connected in parallel to the mechanical switch Mx1. The inter-unit connection switch SWx1C is connected between the first terminal of the intra-unit switch SW1C and the second terminal of the intra-unit switch SW2C. The inter-unit connection switch SWx2C may include a mechanical switch Mx2 and a diode Dx2. The diode Dx2 is connected in parallel to the mechanical switch Mx2. The inter-unit connection switch SWx2C is connected between the first terminal of the intra-unit switch SW2C and the second terminal of the intra-unit switch SW3C.

The inter-unit connection switch SWx3C may include a mechanical switch Mx3 and a diode Dx3. The diode Dx3 is connected in parallel to the mechanical switch Mx3. The inter-unit connection switch SWx3C is connected between the first terminal of the intra-unit switch SW3C and the second terminal of the intra-unit switch SW4C.

The control unit 24 controls the on state and off state of the inter-unit connection switches SWx1C-SWx3C and the intra-unit switch SWC. For example, the control unit 24 controls the connection of the cells B1_1-B4_3 so that it has a 3 series and 4 parallel state or a 4 series and 3 parallel state.

Operation when charging and discharging of the series-parallel conversion power device 21C are performed may be the same as those performed when charging and discharging the aforementioned embodiment, except that the self-commutated semiconductor switch has been substituted with the mechanical switch.

As described above, in the series-parallel conversion power device 21C of the present exemplary embodiment, the intra-unit switch SW of the first exemplary embodiment has been substituted with the intra-unit switch SWC, and the inter-unit connection switch SWx thereof has been substituted with the inter-unit connection switch SWxC. Furthermore, the intra-unit switch SWC and the inter-unit connection switch SWxC include the mechanical switches and the diodes connected in parallel to the respective mechanical switches. Accordingly, the third embodiment may have the same effects as the first exemplary embodiment.

Furthermore, in the series-parallel conversion power device 21C of the present exemplary embodiment, a loss of conduction when a current passes through the intra-unit switch SWC and the inter-unit connection switch SWxC can be reduced compared to the second exemplary embodiment because the mechanical switch other than the self-commutated semiconductor switch is used. Accordingly, the series-parallel conversion power device 21C of the present exemplary embodiment can further reduce a loss compared to the second exemplary embodiment.

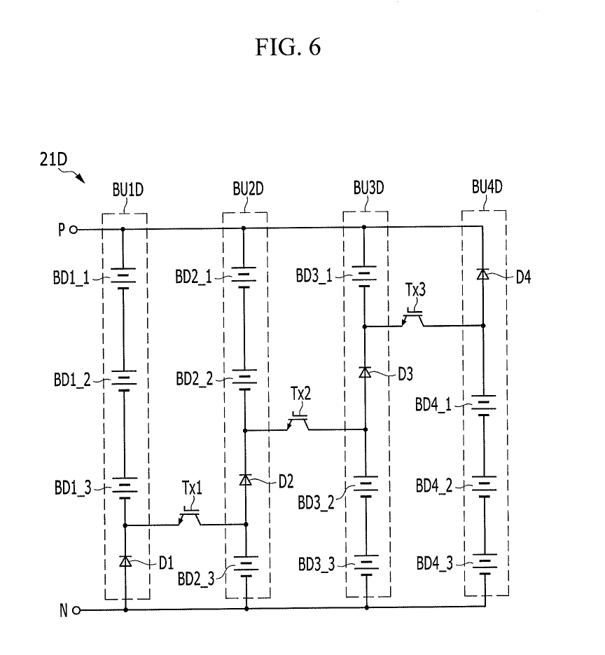

FIG. 6 illustrates another embodiment of a series-parallel conversion power device 21D for a power system. In the present exemplary embodiment, the intra-unit switch SW of the first exemplary embodiment has been substituted with a diode, the inter-unit connection switch SWx thereof has been substituted with a self-commutated semiconductor switch, and the cell B thereof has been substituted with a cell BD. For illustrative purposes, the case where n=4 is described.

As illustrated in FIG. 6, the series-parallel conversion power device 21D may include four cell series connection units BU1D-BU4D and three self-commutated semiconductor switches Tx1-Tx3. The cell series connection units BU1D-BU4D are installed in parallel between a positive electrode charging/discharging terminal P and a negative electrode charging/discharging terminal N.

The cell series connection unit BU1D may include three cells BU1D (e.g., cells BD1_1-BD1_3) and a diode D1. The cell BD1_1 is a cell incapable of charging and may be a primary cell, for example. The cell BD1_1 has a positive electrode terminal connected to the positive electrode charging/discharging terminal P. The cell BD1_2 has a positive electrode terminal connected to the negative electrode terminal of the cell BD1_1 and has a negative electrode terminal connected to the positive electrode terminal of the cell BD1_3. The cell BD1_3 has a negative electrode terminal connected to the diode D1. The diode D1 has a cathode connected to the negative electrode terminal of the cell BD1_3. The diode D1 has an anode connected to the negative electrode charging/discharging terminal N.

As described above, in the cell series connection unit BU1D, the cell BD1_1, the cell BD1_2, the cell BD1_3, and the diode D1 are sequentially connected in series from the positive electrode charging/discharging terminal P.

The cell series connection unit BU2D may include three cells BD2 (e.g., cells BD2_1-BD2_3) and a diode D2. The cell BD2_1 has a positive electrode terminal connected to the positive electrode charging/discharging terminal P. The cell BD2_2 has a positive electrode terminal connected to the negative electrode terminal of the cell BD2_1 and has a negative electrode terminal connected to the cathode of the diode D2. The cell BD2_3 has a positive electrode terminal connected to the anode of the diode D2 and has a negative electrode terminal connected to the negative electrode charging/discharging terminal N. The diode D2 is connected in series between the cell BD2_3 (e.g., the first cell from the negative electrode charging/discharging terminal N) and the cell BD2_2 (e.g., the second cell from the negative electrode charging/discharging terminal N).

As described above, in the cell series connection unit BU2D, the cell BD2_1, the cell BD2_2, the diode D2, and the cell BD2_3 are sequentially connected in series from the positive electrode charging/discharging terminal P.

The cell series connection unit BU3D may include three cells BD3_1-BD3_3 and a diode D3. The cell BD3_1 has a positive electrode terminal connected to the positive electrode charging/discharging terminal P and has a negative electrode terminal connected to the cathode of the diode D3. The cell BD3_2 has a positive electrode terminal connected to the anode of the diode D3 and has a negative electrode terminal connected to the positive electrode terminal of the cell BD3_3. The cell BD3_3 has a negative electrode terminal connected to the negative electrode charging/discharging terminal N. The diode D3 is connected in series between the cell BD3_2, that is, the second cell from the negative electrode charging/discharging terminal N, and the cell BD3_1, that is, the third cell from negative electrode charging/discharging terminal N.

As described above, in the cell series connection unit BU3D, the cell BD3_1, the diode D3, the cell BD3_2, and the cell BD3_3 are sequentially connected in series from the positive electrode charging/discharging terminal P.

The cell series connection unit BU4D may include three cells BD4_1-BD4_3 and a diode D4. The cell BD4_1 has a positive electrode terminal connected to the anode of the diode D4 and has a negative electrode terminal connected to the positive electrode terminal of the cell BD4_2. The cell BD4_2 has a negative electrode terminal connected to the positive electrode terminal of the cell BD4_3. The cell BD4_3 has a negative electrode terminal connected to the negative electrode charging/discharging terminal N. The diode D4 has a cathode connected to the positive electrode charging/discharging terminal P and has an anode connected to the positive electrode terminal of the cell BD4_1.

As described above, in the cell series connection unit BU4D, the diode D4, the cell BD4_1, the cell BD4_2, and the cell BD4_3 are sequentially connected in series from the positive electrode charging/discharging terminal P.

The self-commutated semiconductor switches Tx1-Tx3 are connected between the cell series connection units BU1D-BU4D. The self-commutated semiconductor switch Tx1 is connected between the cathode of the diode D1 and the anode of the diode D2. The self-commutated semiconductor switch Tx2 is connected between the cathode of the diode D2 and the anode of the diode D3. The self-commutated semiconductor switch Tx3 is connected between the cathode of the diode D3 and the anode of diode D4.

The control unit 24 controls the on state and off state of the self-commutated semiconductor switches Tx1-Tx3. For example, the control unit 24 controls the connection of the cells BD1_1-BD4_3 so that it has the 3 series and 4 parallel state or the 4 series and 3 parallel state.

Operation in the 3 series and 4 parallel state and the 4 series and 3 parallel state when the discharging of the series-parallel conversion power device 21D is performed are described below. Operation for supplying power from the series-parallel conversion power device 21D to the an external device (e.g., an operation of the series-parallel conversion power device 21D upon discharging) is described below.

The control unit 24 controls all of the self-commutated semiconductor switches Tx1-Tx3 to be in the off state. In this case, a current path between the positive electrode charging/discharging terminal P and negative electrode charging/discharging terminal N of the series-parallel conversion power device 21D has the following fourth paths.

The first path is the path of the negative electrode charging/discharging terminal N, the diode D1, the cell BD1_3, the cell BD1_2, the cell BD1_1, and the positive electrode charging/discharging terminal P.

The second path is the path of the negative electrode charging/discharging terminal N, the cell BD2_3, the diode D2, the cell BD2_2, the cell BD2_1, and the positive electrode charging/discharging terminal P.

The third path is the path of the negative electrode charging/discharging terminal N, the cell BD3_3, the cell BD3_2, the diode D3, the cell BD3_1, and the positive electrode charging/discharging terminal P.

The fourth path is the path of the negative electrode charging/discharging terminal N, the cell BD4_3, the cell BD4_2, the cell BD4_1, the diode D4, and the positive electrode charging/discharging terminal P.

As described above, the series-parallel conversion power device 21D performs a discharging operation in the state in which the connections of the cells BD has the 3 series and 4 parallel state. In this case, loads may be uniformly distributed to the cells BD due to the symmetricity of circuits.

If the cell BD continues to be discharged in the state in which the connection of the cell BD has the 3 series and 4 parallel state and thus a cell voltage thereof becomes less than a predetermined threshold, the control unit 24 controls all of the self-commutated semiconductor switches Tx1-Tx4 so that they become an on state. In this case, a current path between the positive electrode charging/discharging terminal P and negative electrode charging/discharging terminal N of the series-parallel conversion power device 21D upon discharging has the following three paths.

The first path is the path of the negative electrode charging/discharging terminal N, the cell BD2_3, the self-commutated semiconductor switch Tx1, the cell BD1_3, the cell BD1_2, the cell BD1_1, and the positive electrode charging/discharging terminal P.

The second path is the path of the negative electrode charging/discharging terminal N, the cell BD3_3, the cell BD3_2, the self-commutated semiconductor switch Tx2, the cell BD2_2, the cell BD2_1, and the positive electrode charging/discharging terminal P.

The third path is the path of the negative electrode charging/discharging terminal N, the cell BD4_3, the cell BD4_2, the cell BD4_1, the self-commutated semiconductor switch Tx3, the cell BD3_1, and the positive electrode charging/discharging terminal P.

As described above, the series-parallel conversion power device 21D performs a discharging operation in the state in which the connection of the cell BD has the 4 series and 3 parallel state. In this case, loads may be uniformly distributed to the cells BD due to circuit symmetry. Furthermore, a voltage between the positive electrode charging/discharging terminal P and the negative electrode charging/discharging terminal N can be raised about 4/3 times by changing the connection of the cells of the series-parallel conversion power device 21D from the 3 series and 4 parallel state to the 4 series and 3 parallel.

As described above, in the series-parallel conversion power device 21D of the present exemplary embodiment, the intra-unit switches SW1-SW4 of the first exemplary embodiment have been substituted with the diodes, and the inter-unit connection switches SWx1-SWx3 thereof have been substituted with the self-commutated semiconductor switches. Accordingly, in the discharging of the series-parallel conversion power device 21D, the present exemplary embodiment may have the same effects as those of the first exemplary embodiment.

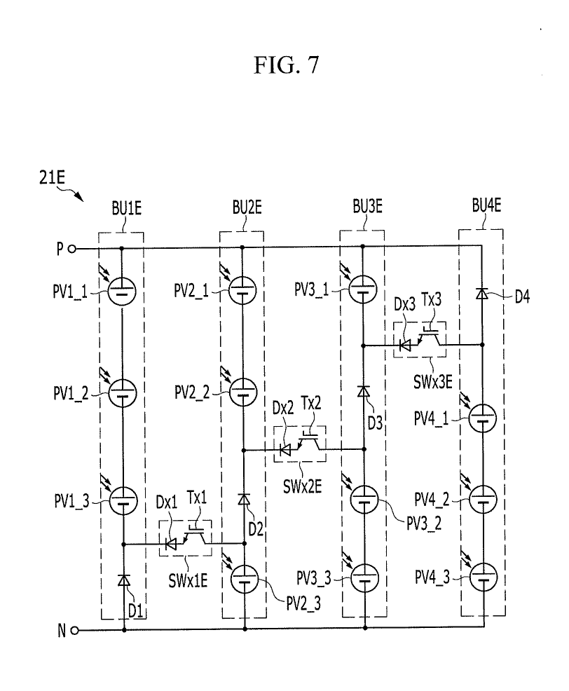

FIG. 7 illustrates another embodiment of a series-parallel conversion power device 21E for a power system. In the present exemplary embodiment, the intra-unit switch SW of the first exemplary embodiment has been substituted with a diode, the inter-unit connection switch SWx of the first exemplary embodiment has been substituted with an inter-unit connection switch SwxE, and the cell B of the first exemplary embodiment has been substituted with a solar cell PV. Also, for illustrative purposes the case where n=4 is described.

As illustrated in FIG. 7, the series-parallel conversion power device 21E may include four cell series connection units BU1E-BU4E and three inter-unit connection switches SWx1E-SWx3E. The cell series connection units BU1E-BU4E are installed in parallel between a positive electrode charging/discharging terminal P and a negative electrode charging/discharging terminal N. The cell series connection unit BU1E may include three solar cells PV1_1-PV1_3 and a diode D1.

The solar cell PV1_1 has a positive electrode terminal connected to the positive electrode charging/discharging terminal P. The solar cell PV1_2 has a positive electrode terminal connected to the negative electrode terminal of the solar cell PV1_1 and has a negative electrode terminal connected to the positive electrode terminal of the solar cell PV1_3. The solar cell PV1_3 has a negative electrode terminal connected to the diode D1. The diode D1 has a cathode connected to the negative electrode terminal of the solar cell PV1_3. The diode D1 has an anode connected to the negative electrode charging/discharging terminal N.

As described above, in the cell series connection unit BU1E, the solar cell PV1_1, the solar cell PV1_2, the solar cell PV1_3, and the diode D1 are sequentially connected in series from the positive electrode charging/discharging terminal P.

The cell series connection unit BU2E may include three solar cells PV2_1-PV2_3 and a diode D2. The solar cell PV2_1 has a positive electrode terminal connected to the positive electrode charging/discharging terminal P. The solar cell PV2_2 has a positive electrode terminal connected to the negative electrode terminal of the solar cell PV2_1 and has a negative electrode terminal connected to the cathode of diode D2. The solar cell PV2_3 has a positive electrode terminal connected to the anode of the diode D2 and has a negative electrode terminal connected to the negative electrode charging/discharging terminal N. The diode D2 is connected in series between the solar cell PV2_3. e.g., the first cell from the negative electrode charging/discharging terminal N, and the solar cell PV2_2, e.g., the second cell from the negative electrode charging/discharging terminal N.

As described above, in the cell series connection unit BU2E, the solar cell PV2_11, the solar cell PV2_2, the diode D2, and the solar cell PV2_3 are sequentially connected in series from the positive electrode charging/discharging terminal P.

The cell series connection unit BU3E may include three solar cells PV3_1-PV3_3 and a diode D3. The solar cell PV3_1 has a positive electrode terminal connected to the positive electrode charging/discharging terminal P and has a negative electrode terminal connected to the cathode of the diode D3. The solar cell PV3_2 has a positive electrode terminal connected to the anode of the diode D3 and has a negative electrode terminal connected to the positive electrode terminal of the solar cell PV3_3. The solar cell PV3_3 has a negative electrode terminal connected to the negative electrode charging/discharging terminal N. The diode D3 is connected in series between the solar cell PV3_2, that is, the second cell from the negative electrode charging/discharging terminal N, and the solar cell PV3_1, that is, the third cell from the negative electrode charging/discharging terminal N.

As described above, in the cell series connection unit BU3E, the solar cell PV3_1, the diode D3, the solar cell PV3_2, and the solar cell PV3_3 are sequentially connected in series from the positive electrode charging/discharging terminal P.

The cell series connection unit BU4E may include three solar cells PV4_1-PV4_3 and a diode D4. The solar cell PV4_1 has a positive electrode terminal connected to the anode of the diode D4 and has a negative electrode terminal connected to the positive electrode terminal of the solar cell PV4_2. The solar cell PV4_2 has a negative electrode terminal connected to the positive electrode terminal of solar cell PV4_3. The solar cell PV4_3 has a negative electrode terminal connected to the negative electrode charging/discharging terminal N. The diode D4 has a cathode connected to the positive electrode charging/discharging terminal P and has an anode connected to the positive electrode terminal of the solar cell PV4_1.

As described above, in the cell series connection unit BU4E, the diode D4, the solar cell PV4_1, the solar cell PV4_2, and the solar cell PV4_3 are sequentially connected in series from the positive electrode charging/discharging terminal P.

The inter-unit connection switches SWx1E-SWx3E are connected between the cell series connection units BU1E-BU4E. The inter-unit connection switch SWx1E may include a self-commutated semiconductor switch Tx1 and a diode Dx1. The diode Dx1 is connected in series to the self-commutated semiconductor switch Tx1. In other words, the anode of the diode Dx1 is connected to the second terminal of the self-commutated semiconductor switch Tx1. The cathode of the diode Dx1 is connected to the cathode of the diode D1.

The self-commutated semiconductor switch Tx1 has a first terminal connected to the anode of the diode D2. For example, the inter-unit connection switch SWx1E is connected between the cathode of the diode D1 and the anode of the diode D2.

The inter-unit connection switch SWx2E may include a self-commutated semiconductor switch Tx2 and a diode Dx2. The diode Dx2 is connected in series to the self-commutated semiconductor switch Tx2. For example, the anode of the diode Dx2 is connected to the second terminal of the self-commutated semiconductor switch Tx2. The cathode of the diode Dx2 is connected to the cathode of the diode D2.

The self-commutated semiconductor switch Tx2 has a first terminal connected to the anode of the diode D3. For example, the inter-unit connection switch SWx2E is connected between the cathode of the diode D2 and the anode of the diode D3. The inter-unit connection switch SWx3E may include a self-commutated semiconductor switch Tx3 and a diode Dx3. The diode Dx3 is in series connected to the self-commutated semiconductor switch Tx3. For example, the anode of the diode Dx3 is connected to the second terminal of the self-commutated semiconductor switch Tx3. The cathode of the diode Dx3 is connected to the cathode of the diode D3.

The self-commutated semiconductor switch Tx3 has a first terminal connected to the anode of the diode D4. For example, the inter-unit connection switch SWx3E is connected between the cathode of the diode D3 and the anode of the diode D4.

The control unit 24 controls the on state and off state of the self-commutated semiconductor switches Tx1-Tx3. For example, the control unit 24 controls the solar cells PV1_1-PV4_3 so that a connection between the solar cells PV1_1-PV4_3 has the 3 series and 4 parallel state or the 4 series and 3 parallel state.

Operation in the 3 series and 4 parallel state and the 4 series and 3 parallel state when the discharging of the series-parallel conversion power device 21E is performed are described below. Operation for supplying power from the series-parallel conversion power device 21E to an external source (e.g., an operation when the discharging of the series-parallel conversion power device 21E is performed) is described below.

The control unit 24 controls all the self-commutated semiconductor switches Tx1-Tx3 so that they have an off state. In this case, a current path between the positive electrode charging/discharging terminal P and negative electrode charging/discharging terminal N of the series-parallel conversion power device 21E upon discharging, that is, the path of the generation output of the solar cell PV, has the following four paths.

The first path is the path of the negative electrode charging/discharging terminal N, the diode D1, the solar cell PV1_3, the solar cell PV1_2, the solar cell PV1_1, and the positive electrode charging/discharging terminal P.

The second path is the path of the negative electrode charging/discharging terminal N, the solar cell PV2_3, the diode D2, the solar cell PV2_2, the solar cell PV2_1, and the positive electrode charging/discharging terminal P.

The third path is the path of the negative electrode charging/discharging terminal N, the solar cell PV3_3, the solar cell PV3_2, the diode D3, the solar cell PV3_1, and the positive electrode charging/discharging terminal P.

The fourth path is the path of the negative electrode charging/discharging terminal N, the solar cell PV4_3, the solar cell PV4_2, the solar cell PV4_1, the diode D4, and the positive electrode charging/discharging terminal P.

As described above, the series-parallel conversion power device 21E performs a discharging operation in the state in which a connection between the solar cells PV has the 3 series and 4 parallel state. In this case, loads may be uniformly distributed to the cells PV due to circuit symmetry.

The configuration is a configuration when a cell voltage is a predetermined threshold or more because solar radiation to each solar cell PV is sufficient. In the state in which the arrangement of the solar cells PV has the 3 series and 4 parallel state, if the amount of solar radiation to the solar cells PV is reduced and the cell voltage of the solar cells PV is less than a predetermined threshold, the control unit 24 controls all the self-commutated semiconductor switches Tx1-Tx4 so that they have an on state.

In this case, a current path between the positive electrode charging/discharging terminal P and negative electrode charging/discharging terminal N of the series-parallel conversion power device 21E upon discharging, that is, the path of the generation output of the solar cells PV, has the following four paths.

The first path is the path of the negative electrode charging/discharging terminal N, the solar cell PV2_3, the self-commutated semiconductor switch Tx1, the diode Dx1, the solar cell PV1_3, the solar cell PV1_2, the solar cell PV1_1, and the positive electrode charging/discharging terminal P.

The second path is the path of the negative electrode charging/discharging terminal N, the solar cell PV3_3, the solar cell PV3_2, the self-commutated semiconductor switch Tx2, the diode Dx2, the solar cell PV2_2, the solar cell PV2_1, and the positive electrode charging/discharging terminal P.

The third path is the path of the negative electrode charging/discharging terminal N, the solar cell PV4_3, the solar cell PV4_2, the solar cell PV4_1, the self-commutated semiconductor switch Tx3, the diode Dx3, the solar cell PV3_1, and the positive electrode charging/discharging terminal P.

As described above, the series-parallel conversion power device 21E performs a discharging operation in the state in which a connection between the solar cells PV has the 4 series and 3 parallel state. In this case, loads may be uniformly distributed to the cells PV due to the symmetricity of circuits.

A voltage between the positive electrode charging/discharging terminal P and the negative electrode charging/discharging terminal N can be raised about 4/3 times by changing the connection of the solar cells PV of the series-parallel conversion power device 21E from the 3 series and 4 parallel state to the 4 series and 3 parallel.

If a plurality of solar cells is connected in parallel, a backdraft prevention diode needs to be inserted into each cell series connection unit in order to prevent backdraft between the cell series connection units connected in parallel. For example, if solar light is not radiated to some solar cells or cell series connection units for a reason, such as a shadow, the electromotive force of the cell series connection units is reduced.

The backdraft prevention diode functions to prevent a current from reversely flowing from a cell series connection unit to which solar light is sufficiently radiated (e.g., a cell series connection unit that maintains a sufficient electromotive force) to a cell series connection unit having a reduced electromotive force.

In the present exemplary embodiment, in the 3 series and 4 parallel state, the diodes D1-D4 also function as backdraft prevention diodes. Furthermore, in the 4 series 3 parallel state, the diodes Dx1-Dx2 also function as backdraft prevention diodes. Accordingly, a diode for backdraft prevention does not need to be separately added.

As described above, in the series-parallel conversion power device 21E of the present exemplary embodiment, the cells B1_1-B4_3 of the first exemplary embodiment have been substituted with the solar cells PV1_1-PV4_3, the intra-unit switches SW1-SW4 thereof have been substituted with the diodes D1-D4, and the inter-unit connection switches SWx1-SWx3 thereof have been substituted with the inter-unit connection switches SWx1E-SWx4E. Furthermore, the inter-unit connection switches SWx1E-SWx4E include the self-commutated semiconductor switches Tx and the diodes Dx. The diode Dx1 is connected in series to the self-commutated semiconductor switch Tx1.

Accordingly, when the discharging of the series-parallel conversion power device 21E is performed, the present exemplary embodiment may have the same effects as the first exemplary embodiment.

Example embodiments have been disclosed herein, and although specific terms are employed, they are used and are to be interpreted in a generic and descriptive sense only and not for purpose of limitation. In some instances, as would be apparent to one of skill in the art as of the filing of the present application, features, characteristics, and/or elements described in connection with a particular embodiment may be used singly or in combination with features, characteristics, and/or elements described in connection with other embodiments unless otherwise indicated. Accordingly, it will be understood by those of skill in the art that various changes in form and details may be made without departing from the spirit and scope of the invention as set forth in the following claims.

What is claimed is:

1. A series-parallel conversion power device, comprising:
n cell series connection units, each having n−1 cells and one intra-unit switch connected in series; and
a plurality of inter-unit connection switches to connect adjacent cell series connection units of the n cell series connection units, wherein:
the n cell series connection units are disposed in parallel in n columns between a positive electrode charging/discharging terminal and a negative electrode charging/discharging terminal,
the intra-unit switch in a cell series connection unit of a k (k is 1 or more and n or less) column has a first terminal connected to a negative electrode terminal of a k-th cell from the negative electrode charging/discharging terminal or the positive electrode charging/discharging terminal (k=n) and has a second terminal connected to a positive electrode terminal of a (k−1)-th cell from the negative electrode charging/discharging terminal or the negative electrode charging/discharging terminal (k=1), and
the inter-unit connection switch is connected between the first terminal of the intra-unit switch of the k-th column and a second terminal of an intra-unit switch of a (k+1)-th column.

2. The device as claimed in claim 1, wherein:
if the cells have an n−1 series and n parallel state, the intra-unit switch is to be in an on state and the inter-unit connection switch is to be in an off state, and
if the cells have an n series and n−1 parallel state, the intra-unit switch is to be in an off state and the inter-unit connection switch is to be in on state.

3. The device as claimed in claim 1, wherein each of the intra-unit switch and the inter-unit connection switch includes a combination of a self-commutated semiconductor switch and a diode reversely connected in parallel to the self-commutated semiconductor switch.

4. The device as claimed in claim 1, wherein each of the intra-unit switch and the inter-unit connection switch includes a combination of a mechanical switch and a diode connected in parallel to the mechanical switch.

5. The device as claimed in claim 1, wherein:
the intra-unit switch includes a diode, and
the inter-unit connection switch includes a mechanical switch or a self-commutated semiconductor switch.

6. The device as claimed in claim 1, wherein:
the cell includes a solar cell,
the intra-unit switch includes a diode, and
the inter-unit connection switch includes a switch having a backdraft prevention function.
